(19) United States
(12) Patent Application Publication
(10) Pub. No.: US 2024/0168511 A1
(43) Pub. Date: May 23, 2024

(54) OPERATING DEVICE WITH AT LEAST ONE PIVOTABLE OPERATING LEVER

(71) Applicant: Inventus Engineering GmbH, St. Anton i.M. (AT)

(72) Inventors: Stefan Battlogg, St. Anton i.M. (AT); Benjamin Bürkle, Bürs (AT)

(21) Appl. No.: 18/550,165

(22) PCT Filed: Mar. 15, 2022
(86) PCT No.: PCT/EP2022/056664

§ 371 Date: Sep. 12, 2023

(30) Foreign Application Priority Data
Mar. 16, 2021 (DE) 10 2021 106 436.8

(51) Int. Cl. G05G 9/047

(52) U.S. Cl. CPC G05G 9/047; G05G 2009/04766; G05G 2505/00

(57) ABSTRACT

A control device with a control lever and a supporting element on which the control lever is mounted so as to be pivotable about at least a first pivot axis by a first pivot bearing. The control device has a controllable brake mechanism that includes at least a first brake unit for adjusting a kinetic resistance affecting the movability of the control lever about the first pivot axis. The control lever can pivot only jointly with the first deceleration unit.

The present invention relates to an operating device with at least one operating lever and at least one carrying device. The operating lever is mounted on the support device so that it can pivot about at least one first pivot axis by means of at least one first pivot bearing device. The operating device comprises at least one controllable braking device with at least one first braking unit for setting a movement resistance for the movability of the operating lever about the first pivot axis.

In the prior art, such operating devices are used, for example, for joysticks or the like. Operating devices have become known which can output haptic feedback (force feedback) to the user. For example, DE 102020104 810 A1 describes the use of magnetorheological brakes, with which increases in torque or force that can be set very quickly can be generated for the mobility of the operating lever.

However, there is very little installation space available for many uses for such operating devices. This is particularly the case with gamepads (game controllers), which are usually held with both hands and have two control levers, which are each operated with a thumb. With such a large dimensioning, the operating levers could no longer be reached with the thumbs. Also, in other applications and e.g., with joysticks for vehicle or machine control, the space is often very limited.

In addition, a correspondingly high actuating force for the control levers will be created to make the feel as realistic as possible and also to be able to simulate blockages or grids. In combination with the limited installation space, it is therefore very difficult or expensive to generate the necessary high torque with high quality (little interplay, low noise, quick response, continuously controllable).

In contrast, it is the object of the present invention to provide an improved operating device. In this case, the operating device should have a particularly compact design or require little installation space and at the same time be inexpensive to produce.

This object is achieved by an input device having the features of claim 1. Preferred developments of the invention are the subject matter of the dependent claims. Further advantages and features of the present invention result from the description of the exemplary embodiments.

The operating device according to the invention comprises at least one operating lever and at least one carrying device. The operating lever is mounted on the support device so that it can pivot about at least one first pivot axis by means of at least one first pivot bearing device. The operating device comprises at least one controllable braking device with at least one first braking unit for setting a movement resistance for the movability of the operating lever about the first pivot axis. In this case, the operating lever can preferably only be pivoted together with the first brake unit.

In particular, the operating lever and the brake unit are firmly connected to one another. In particular, when the operating lever is pivoted, the first brake unit is always moved as well. In particular, the operating lever can be pivoted both about the first pivot axis and also about a second pivot axis only together with the first brake unit. In particular, the control lever and the brake unit are connected to each other in such a way that the brake unit must always follow the movement of the control lever. In particular, the operating lever and the brake unit remain stationary relative to one another when the operating lever is pivoted. In particular, the position of the brake unit relative to the control lever remains unchanged when the control lever is pivoted.

At least the first brake unit is preferably arranged at least partially within the control lever. Alternatively, or additionally, at least the first brake unit is at least partially arranged on an imaginary axial extension of the operating lever. The applicant reserves the right to claim an operating device according to the preamble of claim 1, in which at least the first brake unit is arranged at least partially within the operating lever and/or at least partially on an imaginary axial extension of the operating lever.

The operating device according to the invention offers many advantages. The special coupling of the brake unit and operating lever offers a significant advantage, so that they can only be swiveled together. In other words, if the operating lever is pivoted when using the operating device, the brake unit must always follow this movement and is always pivoted at the same time as the operating lever. This enables the brake unit to be accommodated in a particularly advantageous and compact manner in relation to the operating lever. The arrangement of the brake unit within the operating lever also offers a considerable advantage. As a result, the brake unit can use the installation space required by the operating lever anyway. This is particularly advantageous when the operating device is to be used for a gamepad or another correspondingly flat or compact device. The arrangement of the brake unit on an imaginary axial extension of the operating lever is also particularly advantageous. This offers a significant space advantage compared to the otherwise common arrangement of the brake unit to the right or left of the operating lever. The first brake unit and the operating lever are preferably arranged in parallel with respect to their longitudinal axes. It is also preferred that the first brake unit and the operating lever are arranged on a common longitudinal axis or congruently with respect to their longitudinal axes. In particular, the longitudinal axes of the first brake unit and the operating lever do not intersect.

The first braking unit is preferably arranged over more than half of its longitudinal extent within the operating lever. In particular, the first brake unit is surrounded radially and preferably coaxially by the operating lever over more than half of its longitudinal extent. The first brake unit can also be arranged completely outside of the operating lever.

It is preferred and advantageous that the operating lever encloses a radial outside of the first brake unit in the manner of a ring. In particular, the first brake unit is completely surrounded by the operating lever. The first brake unit is preferably surrounded by the operating lever over its entire axial length. It is also possible for the first brake unit to be surrounded by the operating lever in this way only over part of its axial extent.

The first brake unit and the operating lever are particularly preferably arranged coaxially to one another. In particular, the operating lever encloses the first brake unit coaxially. In particular, the first brake unit is of essentially cylindrical design. In particular, the operating lever has on the inside a receiving space which corresponds to an outer contour of the first brake unit and in which the first brake unit is arranged.

In an advantageous embodiment, a pivoting movement of the operating lever about the first pivoting axis (in particular by means of a transmission device) can be converted into a rotary movement. The rotary movement can be braked in particular by means of the first brake unit. In particular, by means of the first braking unit, adjustable torque for the rotary movement, which is generated by the pivoting movement of the operating lever. The rotational movement preferably takes place about an axis of rotation which runs transversely and in particular at right angles to the first pivot axis.

In all configurations it is preferred and advantageous that the first brake unit comprises at least two brake components which can be rotated relative to one another about a common axis of rotation. The axis of rotation of the first brake unit preferably runs at least partially within the operating lever. In particular, the brake axis of the first brake unit runs transversely and in particular at right angles to the first pivot axis of the operating lever. In particular, the axis of rotation of the first brake unit runs in the longitudinal direction of the operating lever and preferably congruently with a longitudinal axis of the operating lever. In particular, the operating lever coaxially surrounds the axis of rotation of the first brake unit.

The movement resistance for the movability of the operating lever can be adjusted in particular in that a torque for the relative rotatability of the brake components can be adjusted or is adjusted in relation to one another. In particular, a power transmission between the brake components can be influenced in a targeted manner and particularly preferably can be influenced by a magnetorheological medium.

In particular, one of the brake components is designed as a stationary brake component. In particular, the stationary brake component is coupled to the support device and/or the operating lever in a rotationally fixed manner. The stationary brake component is preferably fastened to the operating lever in a rotationally fixed manner and is also connected to the carrying device in a rotationally fixed manner via a rotationally fixed connection of the operating lever to the carrying device. In particular, the other of the at least two brake components is designed as a rotatable brake component. In particular, the rotatable braking component can be rotated relative to the operating lever and/or to the carrying device. The braking components (of the first braking unit) are in particular arranged coaxially to one another. In particular, the stationary brake component is arranged on the inside. In particular, the outer brake component is arranged relative to the operating lever, in particular the rotatable brake component is arranged on the outside. A brake unit is also possible in which the fixed brake component is arranged on the outside and the rotatable brake component is arranged on the inside.

The rotatable brake component of the first brake unit can preferably be rotated relative to the stationary brake component (and in particular also relative to the support device and/or relative to the operating lever) when and particularly preferably only then when the operating lever pivots about the first pivot axis.

In a preferred and advantageous development, the rotatable brake component of the first brake unit is coupled to the support device with a non-positive fit (in particular a friction fit) and/or a positive fit. As a result, the rotatable brake component is preferably set in a rotary motion when it is pivoted along the support device (in the event of a pivoting movement of the operating lever about the first pivot axis). In this case, the support device can also be provided by a second pivot bearing device, which enables a pivoting movement of the operating lever about a second pivot axis.

It is possible and advantageous for the rotatable braking component of the first braking unit to be coupled to at least one transmission device. In particular, the transmission device is suitable and designed to convert a pivoting movement of the operating lever about the first pivoting axis into a rotary movement and in particular to transmit the rotary movement to the rotatable brake component. As a result, the rotatable brake component rotates in particular about its axis of rotation when the operating lever is pivoted about the first pivot axis. In an advantageous development, the transmission device comprises at least one bevel gear or is designed as such. In this case, the rotatable brake component has, in particular, an axis of rotation which runs transversely to the first pivot axis and in the direction of a longitudinal axis of the operating lever. In particular, the bevel gear is suitable and designed to transmit a relative movement, which occurs transversely to the axis of rotation of the rotatable brake component, to the rotatable brake component as a rotational movement. For example, the bevel gear includes at least one bevel gear and/or a friction gear or is designed as such.

In particular, the transmission device comprises at least one drive part and at least one abutment part. In particular, the drive part is fastened (in particular non-rotatably) to the rotatable brake component. In particular, the abutment part is attached to the support device (particularly stationary). This results in particular in that the abutment part does not move with a pivoting movement of the operating lever about the first pivot axis. In particular, the drive part and the abutment part are coupled to one another in a non-positive (in particular frictional) and/or form-fitting manner. This preferably causes the drive part to rotate as it moves along the abutment part. The drive part and the abutment part can preferably be rotated relative to each other about their own axis of rotation.

In particular, the drive part is arranged at a distance from (e.g. above or below) an intersection point at which the axis of rotation of the drive part intersects the first pivot axis. In particular, when the operating lever pivots about the first pivot axis, the drive part not only performs a rotational movement, but also a pivoting movement. In particular, the drive part is rotated and pivoted at the same time. The drive part and the abutment part preferably complete a pivoting movement of the operating lever about the first pivot axis relative to each other. The relative movement is due in particular to the pivoting movement of the operating lever about the first pivot axis.

In particular, the drive part and the abutment part at least partially provide the bevel gear. In this case, the drive part rotates about an axis of rotation, which is arranged transversely to an axis of the relative movement between the drive part and the abutment part.

The drive part preferably comprises at least one bevel gear wheel or is designed as such. The abutment part preferably comprises at least one tooth section which corresponds to and in particular engages with the bevel gear or is designed as such. In particular, the tooth section is curved. In particular, the curvature of the tooth section follows a pivoting path of the drive part about the first pivot axis. The tooth portion may correspond to a segment of a gear. The tooth portion can also be provided by a gear.

In one embodiment, the drive part can include at least one friction wheel. In particular, the abutment part then comprises at least one rolling section which corresponds to the friction wheel and on which the friction wheel can be rolled. In particular, the rolling section follows a pivoting path of the drive part about the first pivoting axis. Other types of gearing are also possible for transmitting the pivoting movement about the first pivot axis to the rotatable brake component.

It is possible and advantageous for the transmission device to have a transmission. In particular, the transmission device is suitable and designed to rotate the rotatable brake component through an angle that is greater than an angle of the pivoting movement of the operating lever about the first pivot axis. This enables the speed of the first braking unit to be increased, so that braking torques are effective even with very small braking units can be achieved. In particular, a radius of the bevel gear is larger than a radius of curvature of the tooth portion.

In particular, the first brake unit is suitable and designed to adapt a braking torque for the relative rotatability of the brake components to one another and thereby set a movement resistance for the movability of the operating lever. In particular, the second brake unit is also designed in this way.

In particular, at least one magnetorheological medium is arranged between the brake components. In particular, the first braking unit comprises at least one field generating device for generating a magnetic field. In particular, the second brake unit is also designed in this way.

In a particularly preferred and advantageous development, the operating device includes at least one second pivot bearing device. By means of the second pivot bearing device, the operating lever is mounted on the support device such that it can pivot about at least one second pivot axis. In particular, with respect to its longitudinal axis, the first brake unit is arranged transversely to a plane which extends parallel to the first and second pivot axis. In particular, the operating lever is also arranged transversely to this plane in relation to its longitudinal axis. In particular, the first and second pivot axes are arranged transversely to one another. In particular, the first and second pivot axes each lie in one plane or in a common plane. In particular, the two pivot axes intersect. It is also possible that the swivel axes do not intersect. In particular, the first pivot axis extends along an x-axis and the second pivot axis along a y-axis, and the operating lever and the first brake unit and its axis of rotation along a z-axis.

In particular, the operating lever is arranged transversely to the first and second pivoting axis (and in particular also to the plane which extends parallel to the first and second pivoting axis) with respect to its longitudinal axis. In particular, the first brake unit is arranged on the same side of the first and second pivot axes as the operating lever. It is also possible that the operating lever and the first brake unit are arranged on opposite sides of the first and second pivot axis. In particular, the first braking unit is arranged transversely and preferably vertically to the first and second pivot axis.

In particular, the first brake unit and the operating lever are arranged on the same side or on opposite sides of the plane extending parallel to the first and second pivot axes.

The first pivot bearing device is mounted (indirectly) on the support device, in particular via the second pivot bearing device, so that when the operating lever is pivoted about the first pivot axis, the second pivot bearing device can remain stationary, and when the operating lever is pivoted about the second pivot axis, the first pivot bearing device can remain stationary together with the operating lever is also pivoted about the second pivot axis or is pivotable. In particular, the first pivot axis is pivoted about the second pivot axis. In particular, the first pivot bearing device and the second pivot axis are pivotably mounted on the support device.

When the operating lever is pivoted about the second pivot axis, the first brake unit is preferably also pivoted about the second pivot axis.

In all configurations it is preferred that the braking device comprises at least one second braking unit, by means of which a movement resistance for the movability of the operating lever about the second pivot axis can be set. In particular, the second brake unit at least two brake components rotatable relative to one another about a common axis of rotation. In particular, the axis of rotation of the second brake unit runs parallel or congruently to the second pivot axis. In particular, the operating lever can be pivoted about the second pivot axis independently of the first pivot axis and about the first pivot axis independently of the second pivot axis. In particular, a movement resistance can be set independently of one another for the first and second braking unit.

In particular, the axis of rotation of the second brake unit extends parallel to the plane which extends parallel to the first and second pivot axes. The axis of rotation of the second brake unit particularly preferably extends in this plane. However, it is also possible for the axis of rotation of the second brake unit to run transversely to the second pivot axis. Then in particular at least one transmission is interposed. In particular, the second brake unit is arranged outside of the operating lever. In particular, the second brake unit has a longitudinal axis and/or axis of rotation, which runs transversely to the longitudinal axis of the operating lever.

The axis of rotation of the second brake unit preferably runs through an intersection at which the first and second pivot axes intersect. In particular, the rotatable brake component of the second brake unit is arranged around the intersection of the two pivot axes.

The axis of rotation of the second brake unit preferably runs transversely to the axis of rotation of the first brake unit.

In particular, a longitudinal axis of the operating lever intersects the second brake unit and preferably the axis of rotation of the second brake unit. In particular, the longitudinal axis of the operating lever also intersects the first and second pivot axes. In particular, an imaginary extension of the longitudinal axis of the operating lever meant. In particular, the control lever itself does not intersect with these components.

In particular, one of the brake components of the second brake unit is designed as a stationary brake component which is coupled in a rotationally fixed manner to the support device and/or the operating lever. In particular, another of the at least two brake components of the second brake unit is designed as a rotatable brake component. The rotatable brake component is coupled to the second pivot axis in particular by means of at least one gear unit. In particular, the transmission unit includes a gear ratio adapted to the transmission device, so that the pivoting movement of the operating lever can be braked equally for both pivot axes.

In particular, the axis of rotation of the first brake unit is arranged transversely to a plane which extends parallel to the first and second pivot axes.

In particular, the operating lever comprises at least one accommodation space for the first brake unit. The receiving space is in particular surrounded at least partially (radially) by a wall of the operating lever. In particular, the operating lever can be pivoted manually. In particular, the operating lever can be pivoted by means of at least one finger and, for example, a thumb or forefinger. The operating lever can also be referred to as a thumb lever. In particular, by pivoting the operating lever about the first pivot axis and the second pivot axis, an operation and, for example, an input into a device or a machine takes place. In particular, the operating lever is designed to be pivotable about the first and second pivot axis at the same time.

In particular, the operating lever has at least one body for placing at least one finger during operation. In particular, the first braking unit is arranged at least partially and preferably entirely within the body. Especially the body encloses the brake at least partially and in particular completely radially. For example, the operating lever includes a blind hole in which the first brake unit is housed.

It is possible that the operating lever can be pivoted at least partially by a motor. In all configurations, it is possible for the braking device to be designed as a motorized drive and, for example, as an electric motor. It is possible that the movement resistance for the movability of the operating lever is generated in that the motor drive counteracts a manual movement.

The applicant reserves the right to claim a gamepad with at least one and preferably at least two operating devices.

Further advantages and features of the present invention result from the description of the exemplary embodiments, which are explained below with reference to the attached figures.

In the figures show:

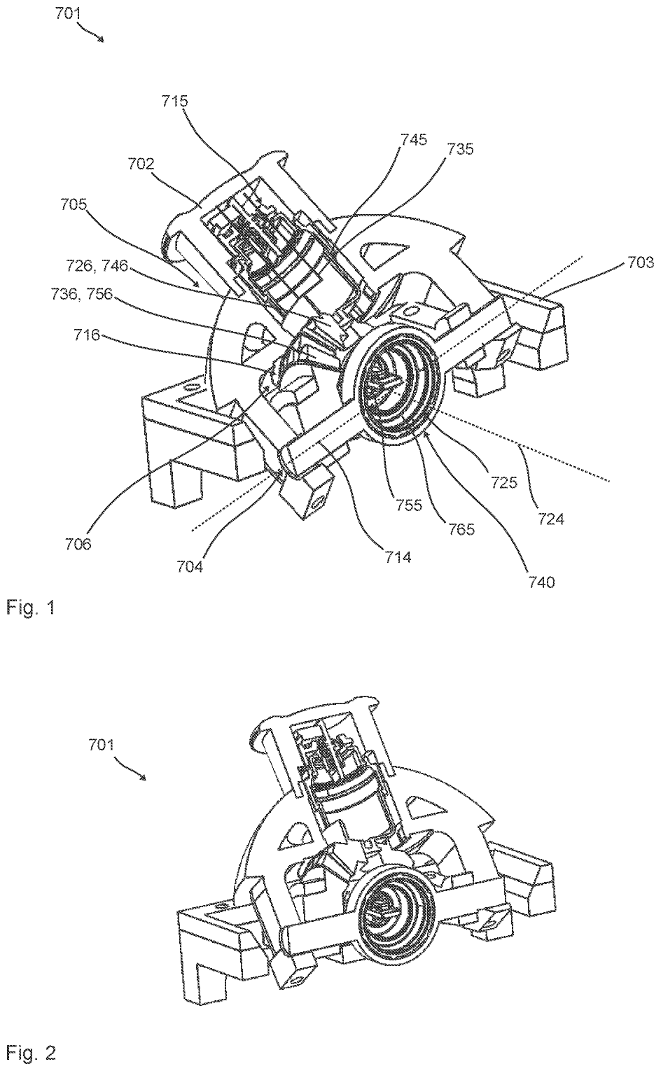

FIG. 1 shows a purely schematic representation of an operating device according to the invention in a sectional perspective view;

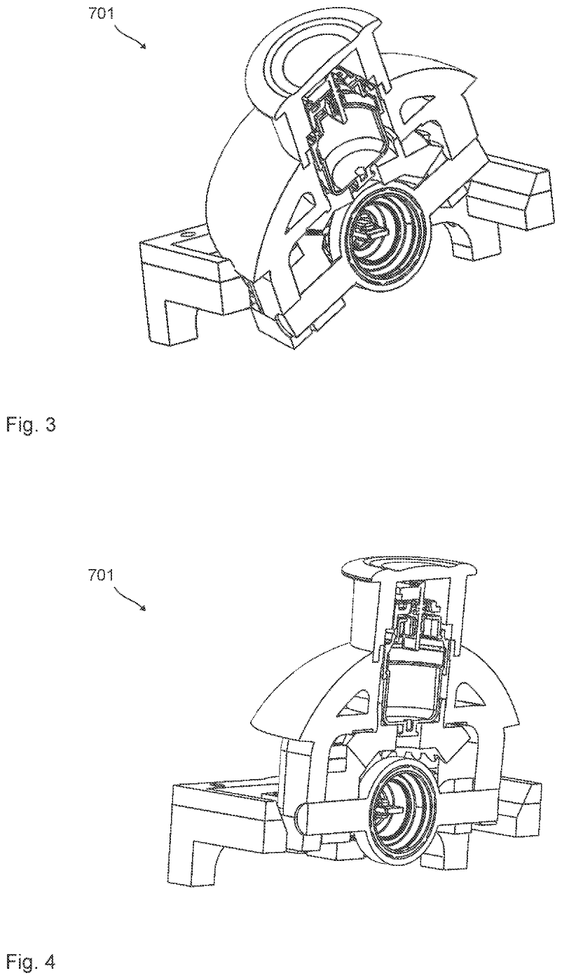

FIG. 2-4 shows the operating device of FIG. 1 with an operating lever in different positions;

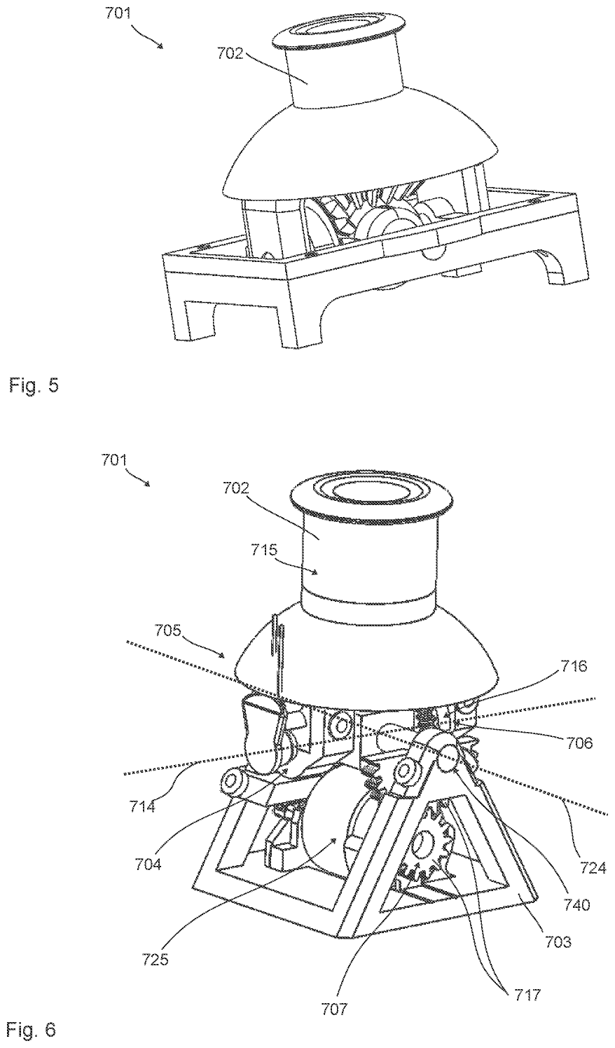

FIG. 5 shows the operating device from FIG. 1 in a perspective view;

FIG. 6 shows a purely schematic representation of a further operating device according to the invention in a perspective view;

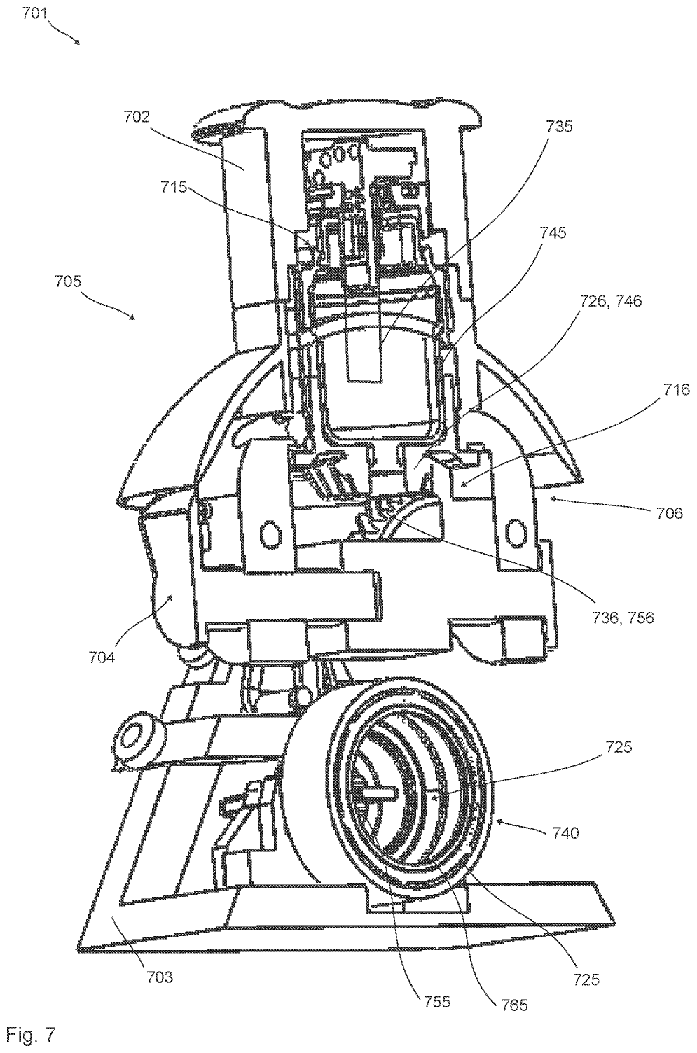

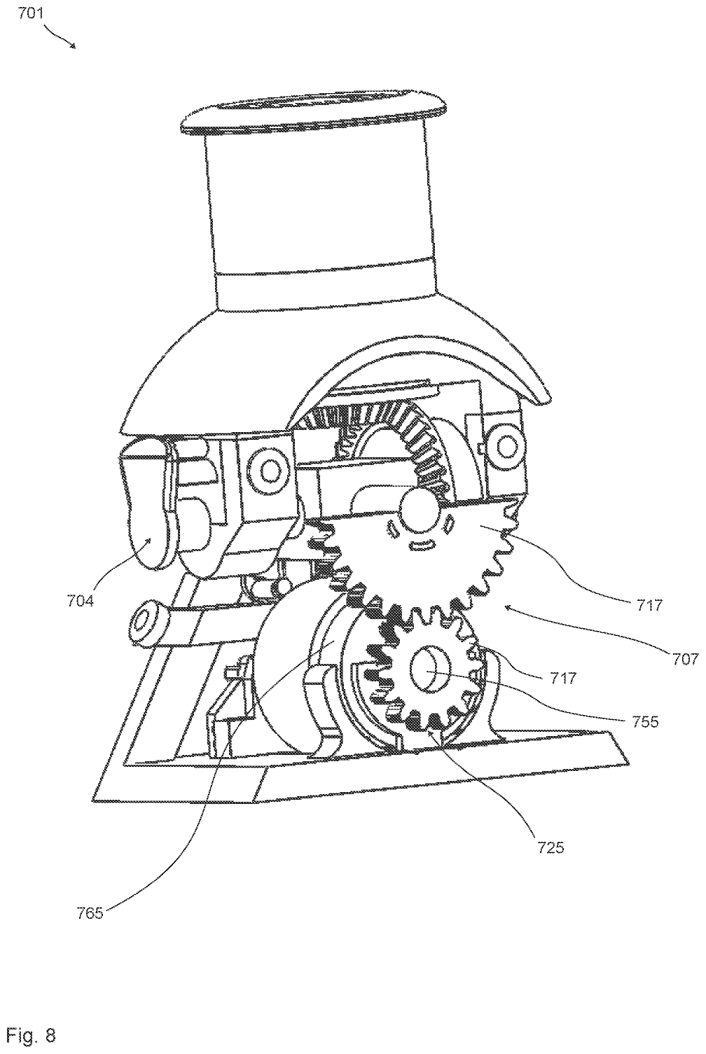

FIG. 7 shows the operating device from FIG. 6 in a perspective sectional view; and

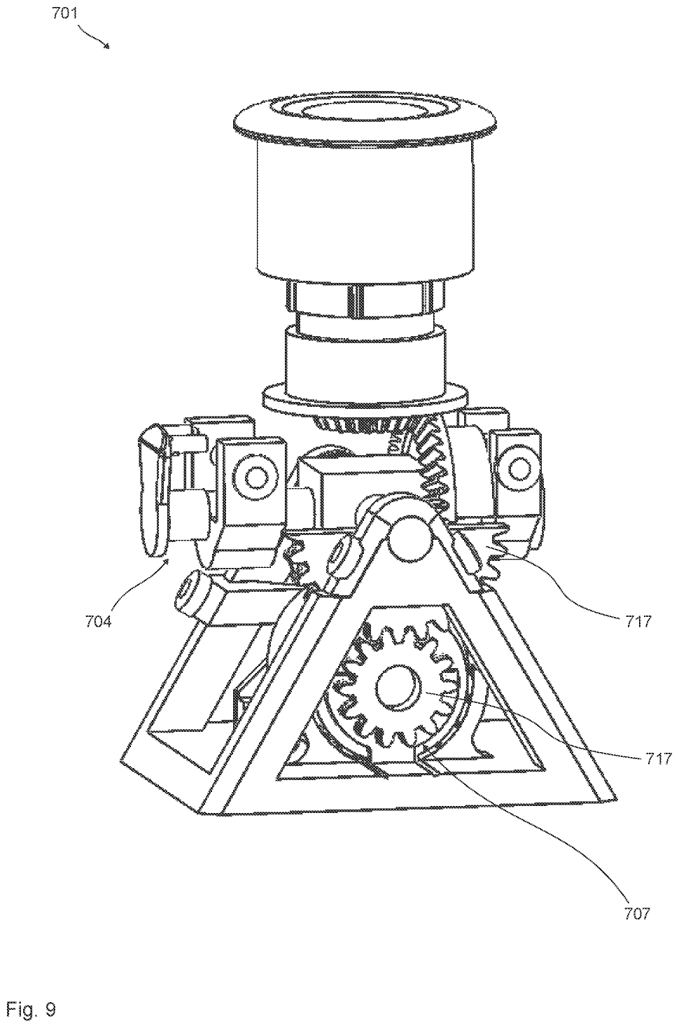

FIG. 8-9 show perspective sectional detail views of the operating device of FIG. 6.

FIG. 1 shows an operating device 701 according to the invention, which can be used, for example, for a gamepad or a particularly compact joystick. The operating device 701 comprises an operating lever 702, which is mounted on a support device 703 so as to be pivotable about a first pivot axis 714 by means of a first pivot bearing device 704 and about a second pivot axis 724 by means of a second pivot bearing device 740. The operating lever 702 is pivoted here, for example, by placing a thumb on the front side or by laterally using one or two fingers.

With a controllable braking device 705, the movement resistance for the mobility of the operating lever 702 can be adjusted in a targeted manner, so that haptic feedback can be output, for example. The braking device 705 comprises a first braking unit 715 for setting the resistance to movement for movements about the first pivot axis 714 and a second braking unit 725 for setting the resistance to movement for movements about the second pivot axis 724. The braking units 715, 725 here each comprise two relative to one another about a common one Axis of rotation rotatable brake components 735, 745, 755, 765.

The first brake unit 715 is arranged inside the operating lever 702 here. As a result, the installation space that is required for the operating lever 702 in any case can be used to accommodate the brake unit 715. In this way, the operating device can be designed to be particularly compact and, for example, particularly flat. The operating lever 702 can only be pivoted together with the brake unit 715.

In order to be able to adapt the movement resistance, the pivoting movement of the operating lever 702 about the first pivoting axis 714 is converted here into a rotary movement by means of a transmission device 706. The rotary movement is then braked or released by the first brake unit 715 as required.

For this purpose, one of the brake components 735, 745 is designed as a fixed brake component 735 and is connected to the operating lever 702 in a rotationally fixed manner. The other brake component 745 is designed as a rotatable brake component 745 and can rotate relative to the fixed brake component 735 within the operating lever 702. The rotatable brake component 745 is operatively connected to the support 703 as described in more detail below. It should be mentioned that both the stationary braking component 735 and the rotatable braking component 745 also move when the operating lever 702 is pivoted and follow the pivoting movements of the operating lever 702.

A drive part 726 embodied as a bevel gear 746 is fastened here to the rotatable brake component 745. When the operating lever 702 pivots about the first pivot axis 714, the drive part 726 meshes with an abutment part 736, which is designed here as a curved toothed section 756. The abutment part 736 is attached to the support device 703 and does not move with the pivoting movement of the operating lever 702 about the first pivot axis 714. The drive part 726 and the abutment part 736 serve here as an angular gear 716, with which the pivoting movement of the operating lever 702 about the first pivot axis 714 is converted into a rotary movement of the brake component 745.

A magnetorheological medium, which is located between the brake components 735, 745, is influenced by means of a field generation device that is not shown in detail here. Depending on the strength of the magnetic field, a certain torque results for the relative rotatability of the brake components 735, 745 to one another.

The movement resistance for the pivoting movement about the second pivot axis 724 is adjusted here with the second brake unit 725. The brake unit 725 functions here essentially as it was previously described for the first brake unit 715.

Here the second brake unit 725 is arranged transversely to the first brake unit 715. In addition, the axis of rotation of the rotatable brake component 765 of the second brake unit 725 extends in an overlapping or congruent manner with the second pivot axis 724. For this purpose, the second brake unit 725 is arranged here at the crossing point of the two pivot axes 714, 724. When operating lever 702 is pivoted about second pivot axis 724, rotatable brake component 765 is set in motion, which can then be subjected to a targeted torque, as described above for first brake unit 715, using a magnetorheological medium and a field-generating device. The fixed brake component 755 is fixed here on the support device 703 in a rotationally fixed manner and is in particular fastened in a rotationally fixed manner.

The second pivot bearing device 740 is mounted directly on the support device 703 here. The first pivot bearing device 704, on the other hand, is mounted indirectly on the support device 703 via the second pivot bearing device 740. The second pivot bearing device 740 thus remains stationary in relation to the support device 703 when the operating lever 702 is moved about the first pivot axis 714. If the operating lever 702 is moved about the second pivot axis 724, the first pivot bearing device 704 together with the first brake unit 715 is also pivoted. The bevel gear 716 is geared here in such a way that the same gear ratio for the first and second brake unit 715, 725 results for a given swivel angle.

In the FIGS. 6 to 9 an embodiment of the operating device 701 is shown, in which for the second brake unit 725 a gear unit 707 with a defined translation is provided. In addition, the radius of the bevel gear wheel 746 in relation to the radius of curvature of the tooth section 756 is selected here in such a way that a transmission ratio for a defined speed increase of the rotatable brake component 745 of the first brake unit 715 results. The translations of the transmission unit 707 of the second brake unit 725 and the transmission device 706 of the first brake unit 715 are matched to one another, so that the same resistance to movement can be felt for both pivot axes 714, 724 on the operating lever.

### LIST OF REFERENCES

701 control device, control device
702 operating lever
703 support device
704 pivot bearing device
705 braking device
706 gear mechanism, transmission device
707 gear unit, transmission unit
714 pivot axis
715 brake unit
716 angular gear, bevel gear
717 spur gear
724 pivot axis
725 brake unit
726 drive part
735 brake component
736 abutment part
740 pivot bearing device
745 brake component
746 bevel gear, gear wheel
755 brake component
756 tooth section
765 brake component

1-30. (canceled)

31. An operating device, comprising:
a support;
an operating lever pivotably mounted on said at least one support about a first pivot axis via a first pivot bearing; and
a controllable brake having a first braking unit configured for setting a movement resistance for a movability of said operating lever about said first pivot axis;
said operating lever being configured to only be pivoted together with said first brake unit.

32. The operating device according to claim 31, wherein said first brake unit is at least partially within said operating lever and/or at least partially on an imaginary axial extension of said operating lever.

33. The operating device according to claim 31, wherein a longitudinal axis of said first brake unit and a longitudinal axis of said operating lever are parallel to one another or lie on a common longitudinal axis.

34. The operating device according to claim 31, wherein said first brake unit has more than half of a longitudinal extent within said operating lever.

35. The operating device according to claim 31, wherein said operating lever encloses a radial outer side of said first brake unit.

36. The operating device according to claim 31, wherein said first brake unit and said operating lever are coaxial to one another.

37. The operating device according to claim 31, wherein a pivoting movement of said operating lever about said first pivot axis is converted into a rotary movement and the rotary movement is be braked by said first brake unit.

38. The operating device according to claim 31, wherein:
said first brake unit has two brake components which are configured to be rotated relative to one another about a common axis of rotation; and
said common axis of rotation is within said operating lever and runs transverse to the first pivot axis of said operating lever.

39. The operating device according to claim 38, wherein:
a first brake component of said two brake components is configured as a fixed brake component which is rotationally fixed to said support and/or said operating lever; and
a second brake component of said two brake components is configured as a rotatable brake component.

40. The operating device according to claim 38, wherein said braking components are coaxial to one another and said first brake component is on an inside.

41. The operating device according to claim 39, wherein said second brake component is configured to be rotated relative to said first brake component during a pivoting movement of said operating lever about said first pivot axis.

42. The operating device according to claim 41, wherein said second brake component is coupled to said support in a non-positive and/or form-fit coupling, and said second brake component is configured to rotate when said second brake component is pivoted along said support.

43. The operating device according to claim 39, wherein said second brake component is coupled to at least one transmission unit, and said transmission unit is configured to:
to convert a pivoting movement of the operating lever about the first pivot axis into a rotational movement; and
to transmit the rotational movement to said rotatable brake component so that said rotatable brake component rotates about an axis of rotation when said operating lever is pivoted about said first pivot axis.

44. The operating device according to claim 43, wherein said transmission unit has at least one bevel gear, and said second brake component has an axis of rotation which is transverse to said first pivot axis and in a direction of a longitudinal axis of said operating lever.

45. The operating device according to claim 44, wherein:
said transmission unit has at least one drive part and at least one abutment part;
said drive part is attached to said rotatable brake component;
said abutment part is attached to said support so that said abutment part does not move when said operating lever pivots about said first pivot axis;
said drive part and said abutment part are coupled to one another non-positive and/or positively, so that said drive part is set in rotary motion when said drive part moves along said abutment part.

46. The operating device according to claim 45, wherein said drive part and said abutment part at least partially provide said bevel gear.

47. The operating device according to claim 45, wherein:
said drive part has at least one bevel gear and said abutment part has at least one tooth section corresponding to said bevel gear; and
said tooth section is curved so that said tooth section follows a pivot path of said drive part about said first pivot axis at least in sections.

48. The operating device according to claim 47, wherein said transmission unit has a gear ratio and is configured to rotate said rotatable brake component by an angle which is greater than an angle of said pivoting movement of said operating lever about said first pivot axis.

49. The operating device according to claim 39, wherein said first brake unit is configured to adapt a torque for a relative rotatability of said brake components to one another and thereby set a movement resistance for a movability of said operating lever.

50. The operating device according to claim 39, further comprising at least one magnetorheological medium between said brake components; and said first brake unit has at least one field generator configured for generating a magnetic field.

51. The operating device according to claim 31, further comprising at least one second pivot bearing, said operating lever being pivotably mounted about at least a second pivot axis on said support via said at least one second pivot bearing, and wherein said first brake unit is, with respect to the longitudinal axis of said first brake unit, transverse to a plane which extends parallel to said first pivot axis and second pivot axis.

52. The operating device according to claim 51, wherein said operating lever is transverse to said first pivot axis and second pivot axis with respect to the longitudinal axis of said operating lever; and said first brake unit is on a same side of said first pivot axis and second pivot axis as said operating lever or said operating lever and said first brake unit are on opposite sides of said first pivot axis and second pivot axis.

53. The operating device according to claim 51, wherein said first pivot bearing is mounted on said support via said second pivot bearing, so that when said operating lever is pivoted about said first pivot axis, said second pivot bearing remains stationary and when said operating lever is pivoted about said second pivot axis, said first pivot bearing is also pivoted together with said operating lever about said second pivot axis.

54. The operating device according to claim 53, wherein when said operating lever is pivoted about said second pivot axis, said first brake unit is also pivoted about said second pivot axis.

55. The operating device according to claim 53, wherein said brake has at least one second braking unit configured for adjusting a movement resistance for a movability of said operating lever about said second pivot axis, said second brake unit has two brake components rotatable relative to each other about a common axis of rotation, and said axis of rotation runs parallel or congruently to said second pivot axis.

56. The operating device according to claim 55, wherein an axis of rotation of said second brake unit runs through an intersection of said two pivot axes.

57. The operating device according to claim 55, wherein an axis of rotation of said second brake unit runs transversely to the axis of rotation of said first brake unit.

58. The operating device according to claim 55, wherein a longitudinal axis of said operating lever intersects said second brake unit.

59. The operating device according to claim 55, wherein:
a first brake components of said second brake unit is configured as a fixed brake component which is non-rotatably connected to said support and/or said operating lever;
a second break component of said second brake unit is configured as a rotatable brake component;
said rotatable brake component is coupled to said second pivot axis by at least one gear unit; and
said gear unit has a gear ratio adapted to said transmission unit, so that a pivoting movement of said operating lever is be braked equally for both pivot axes.

60. The operating device according to claim 55, wherein the axis of rotation of said first brake unit is transverse to a plane which extends parallel to said first and second pivot axis.
